(19) United States
(12) Patent Application Publication
(10) Pub. No.: US 2025/0056498 A1
(43) Pub. Date: Feb. 13, 2025

(54) METHOD AND APPARATUS FOR DETERMINING DOWNLINK CONTROL INFORMATION, METHOD AND APPARATUS FOR RECEIVING DOWNLINK CONTROL INFORMATION, AND DEVICE AND STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/717,991

(22) PCT Filed: Dec. 9, 2021
(86) PCT No.: PCT/CN2021/136886

§ 371 Date: Jun. 7, 2024

(51) Int. Cl. H04W 68/02; H04W 72/232

(52) U.S. Cl. CPC H04W 68/02; H04W 72/232

(57) ABSTRACT

A method for determining downlink control information (DCI) is executed by a network device, and comprises: on the basis of a first search space, determining the number of bits of DCI which is used for bearing a paging early indication (PEI), wherein the first search space is a search space for transmitting the DCI which is used for bearing the PEI.

### CROSS REFERENCE TO RELATED APPLICATION

The present application is the national phase application of International Application No. PCT/CN2021/136886, filed on Dec. 9, 2021, and the entire contents thereof are incorporated herein by reference for all purposes.

### TECHNICAL FIELD

The present disclosure relates to the field of wireless communication technology, and in particular to a method, apparatus, device and storage medium for determining and receiving downlink control information.

### BACKGROUND

When the terminal is in the Radio Resource Control-IDLE (RRC-IDLE)/Radio Resource Control-INACTIVE (RRC-INACTIVE) state, the main behavior of the User Equipment (UE) is to periodically monitor the paging message. After receiving the paging message, it will enter the Radio Resource Control-CONNECTED (RRC-CONNECTED) state for normal communication. The paging message is carried in the Physical Downlink Shared Channel (PDSCH) and needs to be scheduled by the Downlink Control Information (DCI) scrambled by the Paging-Radio Network Temporary Identity (P-RNTI). For a UE, its corresponding Paging Occasion (PO) occurs periodically. The radio frame in which the paging occasion occurs is the paging frame (PF).

In the existing protocol, the UE needs to wake up in each paging cycle for synchronization and for blindly detecting of its paging downlink control information (Paging DCI) in its corresponding paging occasion. In R17, in order to save terminal energy consumption in idle state, the base station can send a paging early indication (PEI) to the terminal. In the existing PEI design, the mechanism adopted is that if the UE receives the PEI corresponding to the UE, and the PEI indicates the UE to wake up, then the UE needs to wake up before the PO corresponding to the PEI to monitor the paging message. If the PEI indicates that the UE not to wake up, or the UE does not receive the corresponding PEI, the UE does not need to wake up, that is, the UE does not need to monitor the PO corresponding to the PEI.

It should be noted that, information disclosed in the above background portion is provided only for better understanding of the background of the present disclosure, and thus it may contain information that does not form the prior art known by those ordinary skilled in the art.

### SUMMARY

In view of this, the present disclosure provides a method, apparatus, device and storage medium for determining and receiving downlink control information.

According to a first aspect of an embodiment of the present disclosure, a method for determining downlink control information (DCI) is provided, which is executed by a network device and includes:
determining, based on a first search space, a number of bits of DCI for carrying a paging early indication (PEI), wherein the first search space is a search space for transmitting the DCI for carrying the PEI.

According to a second aspect of an embodiment of the present disclosure, a method for receiving downlink control information (DCI) is provided, which is executed by a user equipment and includes:
receiving, through a first search space, DCI for carrying a paging early indication (PEI) sent by a network device;
wherein a number of bits of the DCI for carrying the PEI is determined based on the first search space, and the first search space is a search space for transmitting the DCI for carrying the PEI.

According to a third aspect of an embodiment of the present disclosure, an apparatus for determining downlink control information (DCI) is provided, which is executed by a network device and includes:
a processing module, configured to determine, based on a first search space, a number of bits of DCI for carrying a paging early indication (PEI), wherein the first search space is a search space for transmitting the DCI for carrying the PEI.

According to a fourth aspect of an embodiment of the present disclosure, an apparatus for receiving downlink control information (DCI) is provided, which is executed by a user equipment and includes:
a receiving module, configured to receive, through a first search space, DCI for carrying a paging early indication (PEI) sent by a network device;
wherein a number of bits of the DCI for carrying the PEI is determined based on the first search space, and the first search space is a search space for transmitting the DCI for carrying the PEI.

According to a fifth aspect of an embodiment of the present disclosure, a network side device is provided, including:
a processor; and
a memory for storing processor-executable instructions;
wherein the processor is configured to execute the executable instructions in the memory to implement steps of the above method for determining downlink control information (DCI).

According to a sixth aspect of an embodiment of the present disclosure, a mobile terminal is provided, including:
a processor; and
a memory for storing processor-executable instructions;
wherein the processor is configured to execute the executable instructions in the memory to implement steps of the above method for receiving downlink control information (DCI).

According to a seventh aspect of an embodiment of the present disclosure, a non-transitory computer-readable storage medium having executable instructions stored thereon is provided, wherein when the executable instructions are executed by a processor, steps of the above method for determining downlink control information (DCI) or the above method for receiving downlink control information (DCI) are implemented.

It is to be understood that the foregoing general description and the following detailed description are exemplary and explanatory only and are not restrictive of the present disclosure.

### BRIEF DESCRIPTION OF THE DRAWINGS

The drawings described herein are used to provide a further understanding of the embodiments of the present disclosure and constitute a part of this application. The illustrative embodiments of the embodiments of the present disclosure and their descriptions are used to explain the embodiments of the present disclosure and do not constitute an improper limitation on the embodiments of the present disclosure. In the drawings:

The accompanying drawings herein are incorporated in and constitute a part of the specification, illustrate embodiments consistent with the embodiments of the present disclosure, and together with the description, serve to explain the principles of the embodiments of the present disclosure.

FIG. 1 is a flow chart showing a method for determining DCI according to an exemplary embodiment;

FIG. 2 is a flow chart showing a method for determining DCI according to an exemplary embodiment;

FIG. 3 is a flow chart showing a method for determining DCI according to an exemplary embodiment;

FIG. 4 is a flow chart showing a method for determining DCI according to an exemplary embodiment;

FIG. 5 is a flow chart showing a method for receiving DCI according to an exemplary embodiment;

FIG. 6 is a block diagram showing an apparatus for determining DCI according to an exemplary embodiment;

FIG. 7 is a block diagram of an apparatus for receiving DCI according to an exemplary embodiment;

FIG. 8 is a structural diagram of a device for receiving DCI according to an exemplary embodiment; and

FIG. 9 is a structural diagram showing a device for determining DCI according to an exemplary embodiment.

### DETAILED DESCRIPTION

The embodiments of the present disclosure are now further described in conjunction with the accompanying drawings and specific implementation methods.

Exemplary embodiments will be described in detail herein, examples of which are shown in the accompanying drawings. When the following description refers to the drawings, the same reference numerals in different drawings represent the same or similar elements unless otherwise indicated. The implementations described in the following exemplary embodiments do not represent all implementations consistent with the embodiments of the present disclosure. Instead, they are merely examples of apparatus and methods consistent with some aspects of the present disclosure as detailed in the appended claims.

It should be noted that an embodiment of the present disclosure may include multiple steps; for the sake of ease of description, these steps are numbered; however, these numbers do not limit the execution time slots or execution order between the steps; these steps can be implemented in any order, and the embodiment of the present disclosure does not limit this.

Currently, the DCI that carries PEI is tentatively set to DCI format 2-7.

Depending on different configurations, such as the number of frequency domain resource blocks in CORESET 0 and whether it is an unlicensed band, the Paging DCI size can be 37/39/41/43 bits. Currently, the PEI DCI size does not exceed the Paging DCI size.

The network device in the present disclosure may be a base station, and the user equipment may be a terminal.

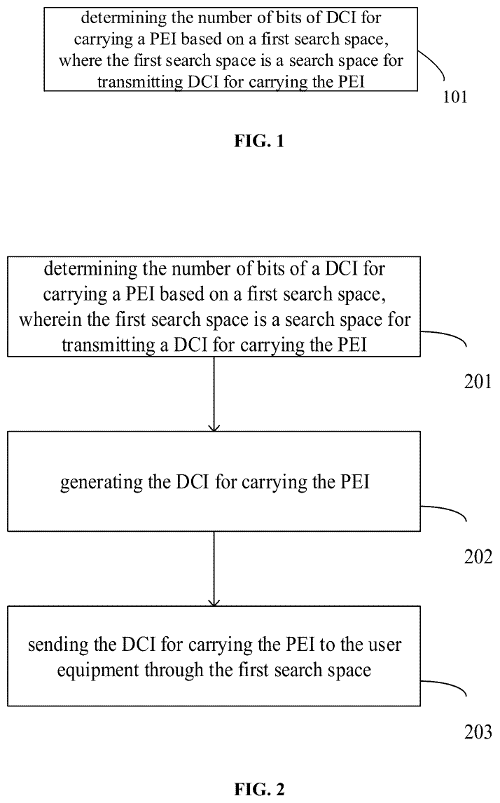

The embodiment of the present disclosure provides a method for determining downlink control information (DCI), which is executed by a network device. The method can be executed independently or in combination with any other embodiment of the embodiment of the present disclosure. FIG. 1 is a flow chart of a method for determining DCI according to an exemplary embodiment. As shown in FIG. 1, the method includes:
Block 101: determining the number of bits of DCI for carrying a Paging Early Indication (PEI) based on a first search space, where the first search space is a search space for transmitting DCI for carrying the PEI.

In one embodiment, the network device determines the number of bits of the DCI for carrying the PEI based on the search space for transmitting the DCI for carrying the PEI. That is, the number of bits of the DCI for carrying the PEI will be different for different search spaces for transmitting the DCI for carrying the PEI.

In the above implementation, the number of bits of the DCI for carrying the PEI is determined based on different situations of the search space for transmitting the DCI for carrying the PEI, so that the determination of the number of bits can reduce the blind detection overhead or improve the detection performance.

In one implementation, in response to the first search space being a paging search space, the network device determines, based on the first search space, that the number of bits of the DCI for carrying the PEI is equal to the number of bits of the paging downlink control information (Paging DCI).

In the above implementation, determining that the number of bits of the DCI for carrying the PEI is equal to the number of bits of the Paging DCI can reduce the blind detection overhead. This is because when the DCI for carrying the PEI and the Paging DCI are transmitted in the same search space, that is, the paging search space, the user equipment needs to monitor the DCI for carrying the PEI (that is, PEI DCI) and the Paging DCI in the paging search space. If the DCI for carrying the PEI and the Paging DCI have the same number of bits, the user equipment only needs to use one DCI size assumption for blind detection decoding during blind detection, and there is no need to use two DCI size assumptions for blind detection decoding separately.

In one implementation, in response to the first search space not being a paging search space, the network device determines, based on the first search space, that the number of bits of the DCI for carrying the PEI is equal to or less than the number of bits of the Paging DCI.

In the above implementation, it is determined that the number of bits of the DCI for carrying the PEI is equal to or less than the number of bits of the Paging DCI, which is conducive to improving detection performance. This is because the DCI for carrying the PEI and the Paging DCI are transmitted in different search spaces, respectively. When the Paging DCI is transmitted in the paging search space, the user equipment uses the Paging DCI size assumption for blind detection; when the DCI for carrying the PEI is transmitted in the search space used for PEI, the search space used for PEI is not a paging search space, and the user equipment uses the PEI DCI size assumption for blind detection. In this case, the size of the DCI for carrying the PEI does not need to be aligned with the size of the paging DCI, so the two DCI size assumptions used for blind detection do not have to be the same for the DCI for carrying the PEI and the Paging DCI. In this case, the size of the DCI for carrying the PEI can be made as small as possible to improve detection performance.

In one embodiment, in response to the first search space being a paging search space, the network device determines, based on the first search space, that the DCI for carrying the PEI includes a first field, and includes any N fields of the second field, the third field, and the fourth field, where N is a positive integer and 0≤N≤3; wherein the first field is a paging indication field, the second field is a tracking reference signal (TRS) availability indication field, the third field is an other information field, and the fourth field is a reserved bit field. That is, when the first search space is a paging search space, the number of bits of the PEI DCI is equal to the number of bits of the Paging DCI, and the number of bits of the PEI DCI is the sum of the number of bits of the fields included in the DCI for carrying the PEI. For example, in one embodiment, in response to the first search space being a paging search space, the network device determines, based on the first search space, that the DCI for carrying the PEI includes a first field, a second field, a third field, and a fourth field, and the sum of the number of bits of the first field, the second field, the third field, and the fourth field is equal to the number of bits of the Paging DCI.

For example, in one embodiment, in response to the first search space being a paging search space, the network device determines, based on the first search space, that the DCI for carrying the PEI includes a first field, a second field, and a third field, and the sum of the number of bits of the first field, the second field, and the third field is equal to the number of bits of the Paging DCI.

For example, in one embodiment, in response to the first search space being a paging search space, the network device determines, based on the first search space, that the DCI for carrying the PEI includes a first field, a second field, and a fourth field, and the sum of the number of bits of the first field, the second field, and the fourth field is equal to the number of bits of the Paging DCI.

It should be understood that the DCI for carrying the PEI must include the above-mentioned first field, while the second field, the third field and the fourth field are not essential, but can be adjusted according to actual needs. In other words, the content included in the DCI carrying PEI must include a paging indication field, which is used to indicate whether there is paging in the corresponding PO. There may also be a TRS availability indication field, which is used to indicate whether there is TRS reference signal information. In addition, there may be other information fields, which are fields that may exist in the future for transmitting other information, such as fields for transmitting short messages, where short messages can be used to notify whether there are system message updates, whether there are tsunamis, earthquakes and other early warning information. It should be noted that the type of information transmitted by the other information field is not limited to one type. For example, in addition to the field for transmitting short messages, the other information field may also include fields for transmitting other types of information. The fourth field is a reserved bit field, which has a padding function, that is, when the sum of the number of bits of the first field, the second field, and the third field is less than the number of bits of the paging DCI, the number of bits of the DCI for carrying the PEI can be equal to the number of bits of the Paging DCI by padding bits, thereby achieving the purpose of reducing the blind detection overhead when the DCI for carrying the PEI and the Paging DCI are transmitted in the same search space. When the sum of the number of bits of the first field, the second field, and the third field is equal to the number of bits of the paging DCI, the fourth field is not required.

In one embodiment, in response to the first search space not being a paging search space, the network device determines, based on the first search space, that the DCI for carrying the PEI includes the first field, and includes any M fields of the second field and the third field, where M is a positive integer and 0≤M≤2; wherein the first field is a paging indication field, the second field is a tracking reference signal availability indication field, and the third field is other information field.

In one embodiment, in response to the first search space not being a paging search space, the network device determines, based on the first search space, that the DCI for carrying the PEI includes a first field, a second field, and a third field, and the sum of the number of bits of the first field, the second field, and the third field is less than or equal to the number of bits of the Paging DCI. That is, when the first search space is not a paging search space, the number of bits of the PEI DCI is less than or equal to the number of bits of the Paging DCI, and the number of bits of the PEI DCI is the sum of the number of bits of the fields included in the DCI for carrying the PEI.

For example, in one embodiment, in response to the first search space not being a paging search space, the network device determines, based on the first search space, that the DCI for carrying the PEI includes a first field and a second field, and the sum of the number of bits of the first field and the second field is less than or equal to the number of bits of the Paging DCI.

For example, in one embodiment, in response to the first search space not being a paging search space, the network device determines, based on the first search space, that the DCI for carrying the PEI includes a first field and a third field, and the sum of the number of bits of the first field and the third field is less than or equal to the number of bits of the Paging DCI.

In the above implementation, since the DCI for carrying the PEI and the Paging DCI are transmitted in different search spaces, the DCI for carrying the PEI does not need to include a padding field to align with the size of the Paging DCI. In this case, the size of the DCI carrying PEI can be made as small as possible to improve detection performance.

The embodiment of the present disclosure provides a method for determining downlink control information (DCI), which is executed by a network device. The method can be executed independently or in combination with any other embodiment of the embodiment of the present disclosure. FIG. 2 is a flow chart of a method for determining DCI according to an exemplary embodiment. As shown in FIG. 2, the method includes:
Block 201, determining the number of bits of a DCI for carrying a Paging Early Indication (PEI) based on a first search space, wherein the first search space is a search space for transmitting a DCI for carrying the PEI;
Block 202, generating the DCI for carrying the PEI;
Block 203: sending the DCI for carrying the PEI to the user equipment through the first search space.

In one embodiment, the network device determines the number of bits of the DCI for carrying the PEI based on the search space for transmitting the DCI for carrying the PEI, then generates the DCI for carrying the PEI based on the determined number of bits, and sends the DCI for carrying the PEI to the user equipment through the first search space.

In one embodiment, in response to the first search space being a paging search space, the network device determines that the number of bits of the DCI for carrying the PEI is equal to the number of bits of the Paging DCI, and generates the DCI for carrying the PEI. Then, based on the determined number of bits, the DCI for carrying the PEI is generated, and the DCI for carrying the PEI is sent to the user equipment through the paging search space, wherein the first radio network temporary identifier (RNTI) is used to scramble the channel for transmitting the DCI for carrying the PEI. The first RNTI is different from the second RNTI that is used to scramble the channel for transmitting the Paging DCI.

In one embodiment, in response to the first search space being a paging search space, the network device determines that the number of bits of the DCI for carrying the PEI is equal to the number of bits of the Paging DCI, and generates the DCI for carrying the PEI. Then, based on the determined number of bits, the DCI for carrying the PEI is generated, and the DCI for carrying the PEI is sent to the user equipment through the paging search space, wherein the channel for carrying the DCI for carrying the PEI is scrambled and transmitted using the Paging Early Indication-radio network temporary identifier (PEI-RNTI). Wherein, PEI-RNTI is different from P-RNTI that is used to scramble the channel for transmitting the Paging DCI.

In the above implementation, when the DCI for carrying the PEI and the Paging DCI are transmitted in the same search space, different RNTIs need to be used to scramble the channel when transmitting the DCI for carrying the PEI and the Paging DCI to distinguish them.

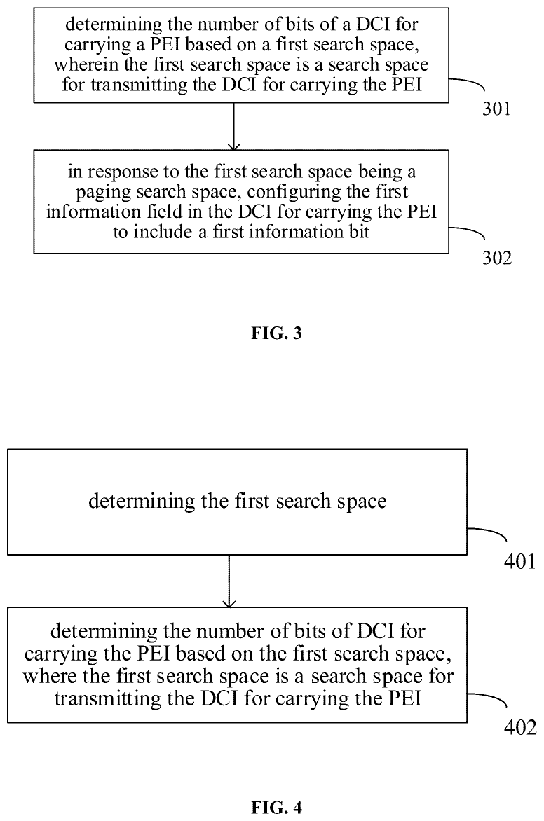

The embodiment of the present disclosure provides a method for determining downlink control information (DCI), which is executed by a network device. The method can be executed independently or in combination with any other embodiment of the embodiment of the present disclosure. FIG. 3 is a flow chart of a method for determining DCI according to an exemplary embodiment, as shown in FIG. 3, the method includes:
Block 301: determining the number of bits of a DCI for carrying a Paging Early Indication (PEI) based on a first search space, wherein the first search space is a search space for transmitting the DCI for carrying the PEI;
Block 302: in response to the first search space being a paging search space, configuring the first information field in the DCI for carrying the PEI to include a first information bit;
wherein the first information field is used to distinguish the DCI for carrying the PEI from the Paging DCI.

In one embodiment, the network device determines that the number of bits of the DCI for carrying the PEI is equal to the number of bits of the Paging DCI based on the search space for transmitting the DCI for carrying the PEI as the paging search space, and then configures the first information field in the DCI for carrying the PEI to include a first information bit, and the first information field is used to distinguish the DCI for carrying the PEI from the Paging DCI.

In one embodiment, the network device determines that the number of bits of the DCI for carrying the PEI is equal to the number of bits of the Paging DCI based on the search space for transmitting the DCI for carrying the PEI as the paging search space, and then configures the first information field in the DCI for carrying the PEI to include the first information bit. The first information field includes 1 bit, and the first information bit is 0, indicating that the DCI is the DCI for carrying the PEI. When the 1 bit of the first information field is 1, it indicates that the DCI is a paging DCI.

It should be noted that, in other implementations, the number of bits in the first information field may be other values.

The contents included in the DCI for carrying the PEI have been described in detail above in conjunction with the embodiments, and will not be repeated here.

In the above implementation, when the DCI for carrying the PEI and the Paging DCI are transmitted in the same search space, the first information field in the DCI for carrying the PEI needs to be configured to be different from the first information field in the Paging DCI, so as to distinguish the DCI for carrying the PEI from the Paging DCI.

The embodiment of the present disclosure provides a method for determining downlink control information (DCI), which is executed by a network device. The method can be executed independently or in combination with any other embodiment of the embodiment of the present disclosure. FIG. 4 is a flow chart of a method for determining DCI according to an exemplary embodiment. As shown in FIG. 4, the method includes:
Block 401, determining the first search space;
Block 402, determining the number of bits of DCI for carrying the Paging Early Indication (PEI) based on the first search space, where the first search space is a search space for transmitting the DCI for carrying the PEI.

In one embodiment, the network device determines that the search space for transmitting DCI carrying PEI is a paging search space, and in response to the search space for DCI carrying PEI being a paging search space, the network device determines that the number of bits of DCI carrying PEI is equal to the number of bits of Paging DCI.

In one embodiment, the network device determines that the search space for transmitting DCI carrying PEI is not a paging search space, and in response to the search space for transmitting DCI carrying PEI being not a paging search space, the network device determines that the number of bits of DCI carrying PEI is less than or equal to the number of bits of Paging DCI.

The contents of the DCI carrying PEI have been described in detail above in conjunction with the embodiments, and will not be repeated here. In the above implementation, the number of bits of the DCI carrying PEI is determined based on different situations of the search space for transmitting the DCI carrying PEI, so that the determination of the number of bits can reduce the blind detection overhead or improve the detection performance.

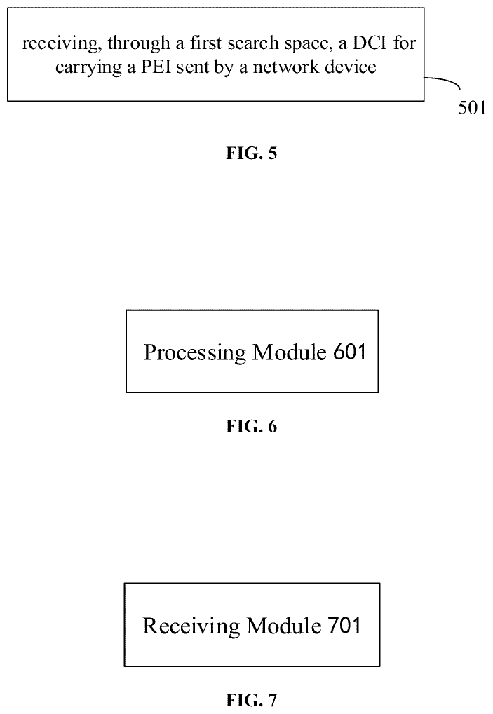

The embodiment of the present disclosure provides a method for receiving downlink control information (DCI), and the method is performed by a user equipment. The method can be performed independently or in combination with any other embodiment of the embodiment of the present disclosure. FIG. 5 is a flowchart of a method for determining DCI according to an exemplary embodiment. As shown in FIG. 5, the method includes:
Block 501, receiving, through a first search space, a DCI for carrying a PEI sent by a network device;
wherein the number of bits of the DCI for carrying the PEI is determined based on the first search space, and the first search space is a search space for transmitting the DCI for carrying the PEI.

In one embodiment, the user equipment receives the DCI for carrying the paging early indication (PEI) sent by the network device through the first search space, wherein the first search space is a search space for transmitting the DCI for carrying the PEI, and the number of bits of the DCI for carrying the PEI is determined based on the first search space. That is, the number of bits of the DCI for carrying the PEI will be different for different search spaces for transmitting the DCI for carrying the PEI.

In one embodiment, in response to the first search space being a paging search space, a DCI for carrying a Paging Early Indication (PEI) sent by a network device is received, wherein the number of bits of the DCI for carrying the PEI is equal to the number of bits of the paging downlink control information (Paging DCI).

In one embodiment, in response to the first search space being a paging search space, a DCI for carrying a Paging Early Indication (PEI) sent by a network device is received, wherein the number of bits of the DCI for carrying the PEI is equal to the number of bits of the paging downlink control information (Paging DCI). Furthermore, when receiving the DCI for carrying the Paging Early Indication (PEI), a first DCI size assumption value is used to perform blind detection on a physical downlink control channel PDCCH. The first DCI size assumption value is the same as the Paging DCI size assumption value.

In the above implementation, the number of bits of the DCI for carrying the PEI is equal to the number of bits of the Paging DCI, which can reduce the blind detection overhead. This is because when the DCI for carrying the PEI and the Paging DCI are transmitted in the same search space, that is, the paging search space, the user equipment needs to monitor the DCI for carrying the PEI and the Paging DCI in the paging search space. If the DCI for carrying the PEI and the Paging DCI have the same number of bits, then the user equipment only needs to use one DCI size assumption value for blind detection decoding during blind detection, and does not need to use two DCI size assumptions for blind detection decoding respectively.

In one embodiment, in response to the first search space not being a paging search space, a DCI for carrying a Paging Early Indication (PEI) sent by a network device is received, wherein the number of bits of the DCI for carrying the PEI is equal to or less than the number of bits of the Paging DCI.

In one embodiment, in response to the first search space not being a paging search space, a DCI for carrying a paging early indication (PEI) sent by a network device is received, wherein the number of bits of the DCI for carrying the PEI is less than or equal to the number of bits of the paging downlink control information (Paging DCI). And when receiving the DCI for carrying the paging early indication (PEI), a second DCI size assumption value is used to perform blind detection on the physical downlink control channel PDCCH. The second DCI size assumption value is the same as or different from the Paging DCI size assumption value.

In the above implementation, the number of bits of the DCI for carrying the PEI is equal to or less than the number of bits of the Paging DCI, which is beneficial to improving detection performance. This is because the DCI for carrying the PEI and the Paging DCI are transmitted in different search spaces, respectively. When the Paging DCI is transmitted in the paging search space, the user equipment uses the Paging DCI size assumption for blind detection; when the DCI carrying PEI is transmitted in the search space used for PEI, and the search space used for PEI is not the paging search space, the user equipment uses the PEI DCI size assumption for blind detection. In this case, the size of the DCI for carrying the PEI does not need to be aligned with the size of the paging DCI, so the two DCI size assumptions used for blind detection do not have to be the same for the DCI for carrying the PEI and the Paging DCI. In this case, the size of the DCI for carrying the PEI can be made as small as possible to improve detection performance.

In one embodiment, in response to the first search space being a paging search space, the DCI for carrying the PEI includes a first field, and includes any N fields among a second field, a third field, and a fourth field, Nis a positive integer, and 0≤N≤3; wherein the first field is a paging indication field, the second field is a tracking reference signal (TRS) availability indication field, the third field is other information field, and the fourth field is a reserved bit field.

In one embodiment, the user equipment receives the DCI for carrying the paging early indication (PEI) sent by the network equipment through the first search space. In response to the first search space being the paging search space, the DCI for carrying the PEI includes a first field, a second field, a third field and a fourth field, and the sum of the number of bits of the first field, the second field, the third field and the fourth field is equal to the number of bits of the Paging DCI.

In one embodiment, the user equipment receives the DCI for carrying the paging early indication (PEI) sent by the network device through the first search space. In response to the first search space being the paging search space, the DCI for carrying the PEI includes a first field, a second field, and a third field, and the sum of the number of bits of the first field, the second field, and the third field is equal to the number of bits of the Paging DCI.

In one embodiment, the user equipment receives the DCI for carrying the paging early indication (PEI) sent by the network device through the first search space. In response to the first search space being the paging search space, the DCI for carrying the PEI includes a first field, a second field, and a fourth field, and the sum of the number of bits of the first field, the second field, and the fourth field is equal to the number of bits of the Paging DCI.

The content included in the DCI carrying PEI must include a paging indication field, which is used to indicate whether there is paging in the corresponding PO. There may also be a TRS availability indication field, which is used to indicate whether there is TRS reference signal information. In addition, there may be other information fields, which are fields for transmitting other information that may exist in the future, such as fields for transmitting short messages, where short messages can be used to notify whether there are system message updates, whether there are tsunamis, earthquakes and other warning information. The fourth field is a reserved bit field, which has a padding function, that is, when the sum of the number of bits in the first field, the second field and the third field is less than the number of bits in the paging DCI, the number of bits in the DCI for carrying the PEI can be made equal to the number of bits in the Paging DCI by padding bits, thereby achieving the purpose of reducing blind detection overhead when the DCI for carrying the PEI and the Paging DCI are transmitted in the same search space.

In one embodiment, in response to the first search space being not a paging search space, the DCI for carrying the PEI includes the first field, and includes any M fields in the second field and the third field, M is a positive integer, and 0≤M≤2; wherein the first field is a paging indication field, the second field is a tracking reference signal availability indication field, and the third field is other information field.

In one embodiment, the user equipment receives the DCI for carrying the paging early indication (PEI) sent by the network device through the first search space. In response to the first search space not being the paging search space, the DCI for carrying the PEI includes a first field, a second field, and a third field, and the sum of the number of bits of the first field, the second field, and the third field is less than the number of bits of the Paging DCI.

In one embodiment, the user equipment receives the DCI for carrying the paging early indication (PEI) sent by the network device through the first search space. In response to the first search space not being the paging search space, the DCI for carrying the PEI includes a first field, a second field, and a third field, and the sum of the number of bits of the first field, the second field, and the third field is equal to the number of bits of the Paging DCI.

In one embodiment, the user equipment receives a DCI for carrying a paging early indication (PEI) sent by a network device through a first search space. In response to the first search space not being a paging search space, the DCI for carrying the PEI includes a first field and a second field, and the sum of the number of bits of the first field and the second field is less than the number of bits of the Paging DCI.

In one embodiment, the user equipment receives the DCI for carrying the paging early indication (PEI) sent by the network device through the first search space. In response to the first search space not being the paging search space, the DCI for carrying the PEI includes a first field and a third field, and the sum of the number of bits of the first field and the third field is less than the number of bits of the Paging DCI.

In the above implementation, since the DCI for carrying the PEI and the Paging DCI are transmitted in different search spaces, the DCI for carrying the PEI does not need to include a padding field to align with the size of the Paging DCI. In this case, the size of the DCI carrying PEI can be made as small as possible to improve detection performance.

The embodiment of the present disclosure provides a method for receiving downlink control information (DCI), which is performed by a user equipment. The method can be performed independently or in combination with any other embodiment of the embodiment of the present disclosure. The method includes:
receiving, through a first search space, a DCI for carrying a Paging Early Indication (PEI) sent by a network device, wherein the number of bits of the DCI for carrying the PEI is determined based on the first search space, and the first search space is a search space for transmitting the DCI for carrying the PEI;
wherein the receiving, through the first search space, a DCI for carrying a PEI sent by a network device includes:
in response to the first search space being a paging search space, a first radio network temporary identifier (RNTI) is used to descramble a channel for transmitting DCI carrying PEI, wherein the first RNTI is different from a second RNTI, and the second RNTI is used to descramble a channel for transmitting Paging DCI.

In one embodiment, the user equipment receives the DCI for carrying the paging early indication (PEI) sent by the network device through the first search space. The first search space is a search space for transmitting the DCI for carrying the PEI, and the number of bits of the DCI for carrying the PEI is determined based on the first search space. In response to the first search space being a paging search space, a first radio network temporary identifier (RNTI) is used to descramble the channel for transmitting the DCI for carrying the PEI, wherein the first RNTI is different from a second RNTI, and the second RNTI is used to descramble the channel for transmitting the Paging DCI.

In one embodiment, a user equipment receives a DCI for carrying a paging early indication (PEI) sent by a network device through a first search space. The first search space is a search space for transmitting a DCI for carrying the PEI, and the number of bits of the DCI for carrying the PEI is determined based on the first search space. In response to the first search space being a paging search space, a channel for transmitting the DCI for carrying the PEI is descrambled using a paging early indication-radio network temporary identifier (PEI-RNTI), wherein PEI-RNTI is different from P-RNTI, and P-RNTI is used to scramble a channel for transmitting Paging DCI.

In the above implementation, when the DCI for carrying the PEI and the Paging DCI are transmitted in the same search space, when receiving the DCI for carrying the PEI and the Paging DCI, different RNTIs need to be used to descramble the channel to distinguish them.

The embodiment of the present disclosure provides a method for receiving downlink control information (DCI), which is performed by a user equipment. The method can be performed independently or in combination with any other embodiment of the embodiment of the present disclosure. The method includes:
receiving, through the first search space, a DCI sent by a network device and for carrying a Paging Early Indication (PEI);
wherein the number of bits of the DCI for carrying the PEI is determined based on the first search space, and the first search space is a search space for transmitting the DCI for carrying the PEI;
wherein, in response to the first search space being a paging search space, the first information field in the DCI for carrying the PEI includes a first information bit, and the first information field is used to distinguish the DCI for carrying the PEI from the Paging DCI.

In one embodiment, the user equipment receives the DCI for carrying the paging early indication (PEI) sent by the network equipment through the first search space. The first search space is a search space for transmitting the DCI for carrying the PEI, and the number of bits of the DCI for carrying the PEI is determined based on the first search space. In response to the first search space being the paging search space, the first information field in the DCI for carrying the PEI includes a first information bit, and the first information field is used to distinguish the DCI for carrying the PEI from the Paging DCI. In one embodiment, the user equipment receives the DCI for carrying the paging early indication (PEI) sent by the network equipment through the first search space. The first search space is a search space for transmitting the DCI for carrying the PEI, and the number of bits of the DCI for carrying the PEI is determined based on the first search space. In response to the first search space being the paging search space, the first information field in the DCI for carrying the PEI includes a first information bit, and the first information bit is 0, indicating that the DCI is the DCI for carrying the PEI. When the 1 bit of the first information field is 1, it indicates that the DCI is a paging DCI.

That is to say, amongst the DCIs, the PEI DCI and the Paging DCI are distinguished through the first information field. For example, if the first information field includes a 1-bit first information bit, when the information bit is 1, it indicates that this DCI is the PEI DCI, and when the information bit is 0, it indicates that this DCI is the Paging DCI. Alternatively, when the information bit is 0, it indicates that this DCI is the PEI DCI, and when the information bit is 1, it indicates that this DCI is the Paging DCI. It should be understood that other information fields and information bit indication and distinction methods are also within the protection scope of the present invention.

In the above implementation, when the DCI for carrying the PEI and the Paging DCI are transmitted in the same search space, the first information field in the DCI for carrying the PEI is different from the first information field in the Paging DCI, thereby distinguishing the DCI for carrying the PEI from the Paging DCI.

An embodiment of the present disclosure provides an apparatus for determining downlink control information (DCI), which is applied to a network device, as shown in FIG. 6, and includes:
a processing module 601, configured to determine a number of bits of the DCI for carrying the Paging Early Indication (PEI) based on a first search space, where the first search space is a search space for transmitting the DCI for carrying the PEI.

An embodiment of the present disclosure provides an apparatus for receiving downlink control information (DCI), which is applied to a user equipment, as shown in FIG. 7, and includes:
a receiving module 701, configured to receive, through the first search space, DCI sent by a network device for carrying a Paging Early Indication (PEI);
wherein a number of bits of the DCI for carrying the PEI is determined based on the first search space, and the first search space is a search space for transmitting the DCI for carrying the PEI.

An embodiment of the present disclosure provides a network side device, including:
a processor; and
a memory for storing processor-executable instructions;
wherein the processor is configured to execute the executable instructions in the memory to implement the steps of the above-mentioned method for determining downlink control information (DCI).

An embodiment of the present disclosure provides a mobile terminal, including:
a processor; and
a memory for storing processor-executable instructions;
wherein the processor is configured to execute the executable instructions in the memory to implement the steps of the above-mentioned method for receiving downlink control information (DCI).

An embodiment of the present disclosure provides a non-temporary computer-readable storage medium having executable instructions stored thereon. When the executable instructions are executed by a processor, the steps of the method for determining downlink control information (DCI) or the method for receiving downlink control information (DCI) are implemented.

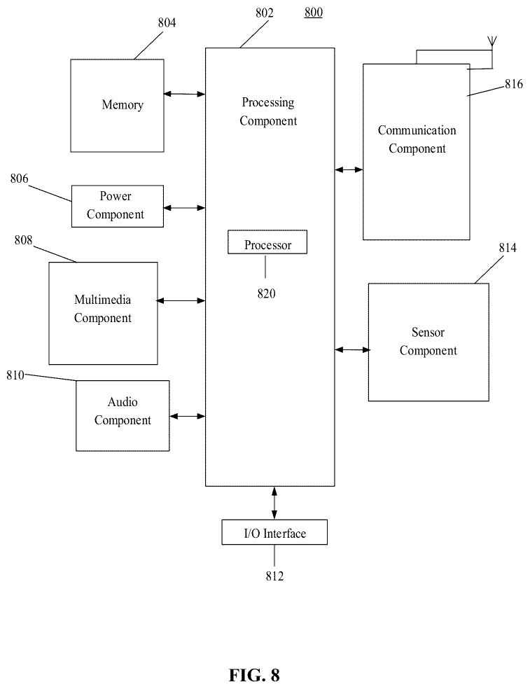

FIG. 8 is a block diagram of an apparatus 800 for receiving downlink control information (DCI) according to an exemplary embodiment. For example, the apparatus 800 can be a mobile phone, a computer, a digital broadcast terminal, a messaging device, a game console, a tablet device, a medical device, a fitness device, a personal digital assistant, and the like.

Referring to FIG. 8, the apparatus 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operations of the apparatus 800, such as operations associated with display, telephone calls, data communications, camera operations, and recording operations. The processing component 802 may include one or more processors 820 to execute instructions to complete all or part of the steps of the above method. Additionally, processing component 802 may include one or more modules that facilitate interaction between processing component 802 and other components. For example, processing component 802 may include a multimedia module to facilitate interaction between multimedia component 808 and processing component 802.

The memory 804 is configured to store various types of data to support operations at the apparatus 800. Examples of such data include instructions for any application or method operating on the terminal 800, contact data, phonebook data, messages, pictures, videos, etc. The memory 804 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 806 provides power to various components of the apparatus 800. The power component 806 may include a power management system, one or more power supplies, and other components associated with generating, managing, and distributing power for apparatus 800.

The multimedia component 808 includes a screen providing an output interface between the apparatus 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or a swipe action, but also detect duration and pressure associated with the touch or swipe operation. In some embodiments, the multimedia component 808 includes a front camera and/or a rear camera. When the apparatus 800 is in an operation mode, such as a photographing mode or a video mode, the front camera and/or the rear camera can receive external multimedia data. Each front camera and rear camera can be a fixed optical lens system or have focal length and optical zoom capability.

The audio component 810 is configured to output and/or input audio signals. For example, the audio component 810 includes a microphone (MIC), which is configured to receive an external audio signal when the apparatus 800 is in an operation mode, such as a call mode, a recording mode and a voice recognition mode. Received audio signals may be further stored in memory 804 or sent via communication component 816. In some embodiments, the audio component 810 also includes a speaker for outputting audio signals.

The I/O interface 812 provides an interface between the processing component 802 and a peripheral interface module, which may be a keyboard, a click wheel, a button, and the like. These buttons may include, but are not limited to: a home button, volume buttons, start button, and lock button.

The sensor component 814 includes one or more sensors for providing apparatus 800 with various aspects of status assessment. For example, the sensor component 814 can detect the open/closed state of the apparatus 800, the relative positioning of components, such as the display and the keypad of the apparatus 800, the sensor component 814 can also detect the apparatus 800 or a change in the position of a component of the apparatus 800, the presence or absence of user's contact with the apparatus 800, the change of orientation or acceleration/deceleration of the apparatus 800 and the temperature change of the apparatus 800. The sensor component 814 may include a proximity sensor configured to detect the presence of nearby objects in the absence of any physical contact. The sensor component 814 may also include an optical sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 is configured to facilitate wired or wireless communication between the apparatus 800 and other devices. The apparatus 800 can access a wireless network based on communication standards, such as Wi-Fi, 2G or 3G, or a combination thereof. In an exemplary embodiment, the communication component 816 receives broadcast signals or broadcast related information from an external broadcast management system via a broadcast channel. In an exemplary embodiment, the communication component 816 also includes a near field communication (NFC) module to facilitate short-range communication. For example, the NFC module can be implemented based on radio frequency identification (RFID) technology, infrared data association (IrDA) technology, ultra wideband (UWB) technology, bluetooth (BT) technology and other technologies.

In an exemplary embodiment, apparatus 800 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing the method described above.

In an exemplary embodiment, there is also provided a non-transitory computer-readable storage medium including instructions, such as the memory 804 including instructions, which can be executed by the processor 820 of the apparatus 800 to implement the above method. For example, the non-transitory computer readable storage medium may be ROM, random access memory (RAM), CD-ROM, magnetic tape, floppy disk, and optical data storage device, and the like.

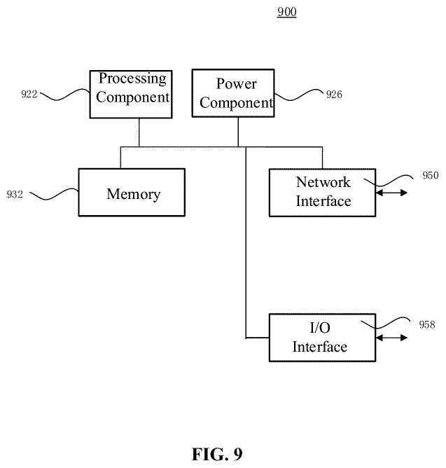

FIG. 9 is a block diagram of an apparatus 900 for determining downlink control information (DCI) according to an exemplary embodiment. For example, the apparatus 900 may be provided as a base station. Referring to FIG. 9, the apparatus 900 includes a processing component 922, which further includes one or more processors, and a memory resource represented by a memory 932 for storing instructions executable by the processing component 922, such as application programs. The application program stored in memory 932 may include one or more modules each corresponding to a set of instructions. In addition, the processing component 922 is configured to execute instructions, so as to perform any of the aforementioned methods for determining and receiving downlink control information (DCI).

The apparatus 900 may also include a power component 926 configured to perform power management of the apparatus 900, a wired or wireless network interface 950 configured to connect the apparatus 900 to a network, and an input-output (I/O) interface 958. The apparatus 900 can operate based on an operating system stored in the memory 932, such as Windows Server™, Mac OS X™, Unix™, Linux™, FreeBSD™ or the like.

According to a first aspect of an embodiment of the present disclosure, a method for determining downlink control information (DCI) is provided, which is executed by a network device and includes:
determining, based on a first search space, a number of bits of DCI for carrying a paging early indication (PEI), wherein the first search space is a search space for transmitting the DCI for carrying the PEI.

In an implementation, the determining, based on the first search space, the number of bits of the DCI for carrying the PEI includes at least one of:
determining, in response to the first search space being a paging search space, that the number of bits of the DCI for carrying the PEI is equal to a number of bits of paging downlink control information (Paging DCI); and
determining, in response to the first search space not being a paging search space, that the number of bits of the DCI for carrying the PEI is equal to or less than the number of bits of the Paging DCI.

In an implementation, the determining, based on the first search space, the number of bits of the DCI for carrying the PEI includes at least one of:
determining, in response to the first search space being a paging search space, that the DCI for carrying the PEI includes a first field and any N fields among a second field, a third field, and a fourth field, wherein N is a positive integer and 0≤N≤3; and
determining, in response to the first search space not being a paging search space, that the DCI for carrying the PEI includes the first field and any M fields among the second field and the third field, wherein M is a positive integer and 0≤M≤2;
wherein the first field is a paging indication field, the second field is a tracking reference signal availability indication field, the third field is an other information field, and the fourth field is a reserved bit field.

In an implementation, the method further includes:
generating the DCI for carrying the PEI;
sending the DCI for carrying the PEI to a user equipment through the first search space.

In an implementation, the sending the DCI for carrying the PEI to the user equipment through the first search space includes:
scrambling, in response to the first search space being a paging search space, a channel for transmitting the DCI for carrying the PEI using a first radio network temporary identifier (RNTI);
wherein, the first RNTI is different from a second RNTI for scrambling a channel for transmitting the Paging DCI.

In an implementation, the first RNTI is a paging early indication-radio network temporary identifier (PEI-RNTI).

In an implementation, the method further includes:
configuring, in response to the first search space being a paging search space, a first information field in the DCI for carrying the PEI to include a first information bit;
wherein the first information field is used to distinguish the DCI for carrying the PEI from the Paging DCI.

In an implementation, the method further includes:
determining the first search space.

According to a second aspect of an embodiment of the present disclosure, a method for receiving downlink control information (DCI) is provided, which is executed by a user equipment and includes:
receiving, through a first search space, DCI for carrying a paging early indication (PEI) sent by a network device;
wherein a number of bits of the DCI for carrying the PEI is determined based on the first search space, and the first search space is a search space for transmitting the DCI for carrying the PEI.

In an implementation, in response to the first search space being a paging search space, the number of bits of the DCI for carrying the PEI is equal to a number of bits of paging downlink control information (Paging DCI); and
in response to the first search space not being a paging search space, the number of bits of the DCI for carrying the PEI is equal to or less than the number of bits of the Paging DCI.

In an implementation, in response to the first search space being a paging search space, the DCI for carrying the PEI includes a first field and any N fields among a second field, a third field, and a fourth field, wherein N is a positive integer and 0≤N≤3; and
in response to the first search space not being a paging search space, the DCI for carrying the PEI includes the first field and any M fields among the second field and the third field, wherein M is a positive integer and 0≤M≤2;
wherein the first field is a paging indication field, the second field is a tracking reference signal availability indication field, the third field is an other information field, and the fourth field is a reserved bit field.

In an implementation, the receiving DCI for carrying the PEI sent by the network device through the first search space includes:
descrambling, in response to the first search space being a paging search space, a channel for transmitting the DCI for carrying the PEI using a first radio network temporary identifier (RNTI);
wherein, the first RNTI is different from a second RNTI for descrambling a channel for transmitting the Paging DCI.

In an implementation, the first RNTI is a paging early indication-radio network temporary identifier (PEI-RNTI).

In an implementation, in response to the first search space being a paging search space, a first information field in the DCI for carrying the PEI includes a first information bit;
wherein the first information field is used to distinguish the DCI for carrying the PEI from the Paging DCI.

According to a third aspect of an embodiment of the present disclosure, an apparatus for determining downlink control information (DCI) is provided, which is executed by a network device and includes:
a processing module, configured to determine, based on a first search space, a number of bits of DCI for carrying a paging early indication (PEI), wherein the first search space is a search space for transmitting the DCI for carrying the PEI.

According to a fourth aspect of an embodiment of the present disclosure, an apparatus for receiving downlink control information (DCI) is provided, which is executed by a user equipment and includes:
a receiving module, configured to receive, through a first search space, DCI for carrying a paging early indication (PEI) sent by a network device;
wherein a number of bits of the DCI for carrying the PEI is determined based on the first search space, and the first search space is a search space for transmitting the DCI for carrying the PEI.

According to a fifth aspect of an embodiment of the present disclosure, a network side device is provided, including:
a processor; and
a memory for storing processor-executable instructions;
wherein the processor is configured to execute the executable instructions in the memory to implement steps of the above method for determining downlink control information (DCI).

According to a sixth aspect of an embodiment of the present disclosure, a mobile terminal is provided, including:
a processor; and
a memory for storing processor-executable instructions;
wherein the processor is configured to execute the executable instructions in the memory to implement steps of the above method for receiving downlink control information (DCI).

According to a seventh aspect of an embodiment of the present disclosure, a non-transitory computer-readable storage medium having executable instructions stored thereon is provided, wherein when the executable instructions are executed by a processor, steps of the above method for determining downlink control information (DCI) or the above method for receiving downlink control information (DCI) are implemented.

The technical solution provided by the embodiments of the present disclosure may have the following beneficial effects:

The number of bits of the DCI for carrying the PEI is determined based on different situations of the search space for transmitting the DCI for carrying the PEI, so that the determination of the number of bits can reduce the blind detection overhead or improve the detection performance.

Other implementations of the embodiments of the present disclosure will be readily apparent to those skilled in the art from consideration of the specification and practice of the invention disclosed herein. This application is intended to cover any modification, use or adaptation of the embodiments of the present disclosure, these modifications, uses or adaptations follow the general principles of the embodiments of the present disclosure and include common knowledge or conventional technical means in the technical field not disclosed in this disclosure. The specification and examples are to be considered exemplary only, with a true scope and spirit of the embodiments of the present disclosure being indicated by the following claims.

It should be understood that the embodiments of the present disclosure are not limited to the precise constructions which have been described above and shown in the accompanying drawings, and various modifications and changes may be made without departing from the scope thereof. The scope of the embodiments of the present disclosure is limited only by the appended claims.

### INDUSTRIAL APPLICABILITY

In the present disclosure, the number of bits of the DCI for carrying the PEI is determined based on different situations of the search space for transmitting the DCI for carrying the PEI, so that the determination of the number of bits can reduce the blind detection overhead or improve the detection performance.

1. A method for determining downlink control information (DCI), performed by a network device, comprising:
determining, based on a first search space, a number of bits of DCI for carrying a paging early indication (PEI), wherein the first search space is a search space for transmitting the DCI for carrying the PEI.

2. The method according to claim 1, wherein the determining, based on the first search space, the number of bits of the DCI for carrying the PEI comprises at least one of:
determining, in response to the first search space being a paging search space, that the number of bits of the DCI for carrying the PEI is equal to a number of bits of paging downlink control information (Paging DCI); and
determining, in response to the first search space not being a paging search space, that the number of bits of the DCI for carrying the PEI is equal to or less than the number of bits of the Paging DCI.

3. The method according to claim 1, wherein the determining, based on the first search space, the number of bits of the DCI for carrying the PEI comprises at least one of:
determining, in response to the first search space being a paging search space, that the DCI for carrying the PEI comprises a first field and any N fields among a second field, a third field, and a fourth field, wherein N is a positive integer and 0≤N≤3; and
determining, in response to the first search space not being a paging search space, that the DCI for carrying the PEI comprises the first field and any M fields among the second field and the third field, wherein M is a positive integer and 0≤M≤2;
wherein the first field is a paging indication field, the second field is a tracking reference signal availability indication field, the third field is an other information field, and the fourth field is a reserved bit field.

4. The method according to claim 1, wherein the method further comprises:
generating the DCI for carrying the PEI;
sending the DCI for carrying the PEI to a user equipment through the first search space.

5. The method according to claim 4, wherein the sending the DCI for carrying the PEI to the user equipment through the first search space comprises:
scrambling, in response to the first search space being a paging search space, a channel for transmitting the DCI for carrying the PEI using a first radio network temporary identifier (RNTI);
wherein, the first RNTI is different from a second RNTI for scrambling a channel for transmitting the Paging DCI.

6. The method according to claim 5, wherein the first RNTI is a paging early indication-radio network temporary identifier (PEI-RNTI).

7. The method according to claim 1, further comprising:
configuring, in response to the first search space being a paging search space, a first information field in the DCI for carrying the PEI to comprise a first information bit;
wherein the first information field is used to distinguish the DCI for carrying the PEI from the Paging DCI.

8. The method according to claim 1, further comprising:
determining the first search space.

9. A method for receiving downlink control information (DCI), performed by a user equipment, comprising:
receiving, through a first search space, DCI for carrying a paging early indication (PEI) sent by a network device;
wherein a number of bits of the DCI for carrying the PEI is determined based on the first search space, and the first search space is a search space for transmitting the DCI for carrying the PEI.

10. The method according to claim 9, wherein,
in response to the first search space being a paging search space, the number of bits of the DCI for carrying the PEI is equal to a number of bits of paging downlink control information (Paging DCI); and
in response to the first search space not being a paging search space, the number of bits of the DCI for carrying the PEI is equal to or less than the number of bits of the Paging DCI.

11. The method according to claim 9, wherein,
in response to the first search space being a paging search space, the DCI for carrying the PEI comprises a first field and any N fields among a second field, a third field, and a fourth field, wherein N is a positive integer and 0≤N≤3; and
in response to the first search space not being a paging search space, the DCI for carrying the PEI comprises the first field and any M fields among the second field and the third field, wherein M is a positive integer and 0≤M≤2;
wherein the first field is a paging indication field, the second field is a tracking reference signal availability indication field, the third field is an other information field, and the fourth field is a reserved bit field.

12. The method according to claim 9, wherein the receiving DCI for carrying the PEI sent by the network device through the first search space comprises:
descrambling, in response to the first search space being a paging search space, a channel for transmitting the DCI for carrying the PEI using a first radio network temporary identifier (RNTI);
wherein, the first RNTI is different from a second RNTI for descrambling a channel for transmitting the Paging DCI.

13. The method according to claim 12, wherein the first RNTI is a paging early indication-radio network temporary identifier (PEI-RNTI).

14. The method according to claim 9, wherein,
in response to the first search space being a paging search space, a first information field in the DCI for carrying the PEI comprises a first information bit;
wherein the first information field is used to distinguish the DCI for carrying the PEI from the Paging DCI.

15-16. (canceled)

17. A network side device, comprising:
a processor; and
a memory for storing processor-executable instructions;
wherein the processor is configured to execute the executable instructions in the memory to implement steps of the method for determining downlink control information (DCI) according to claim 1.

18. A mobile terminal, comprising:
a processor; and
a memory for storing processor-executable instructions;
wherein the processor is configured to execute the executable instructions in the memory to implement:
receiving, through a first search space, downlink control information (DCI) for carrying a paging early indication (PEI) sent by a network device;
wherein a number of bits of the DCI for carrying the PEI is determined based on the first search space, and the first search space is a search space for transmitting the DCI for carrying the PEI.

19. (canceled)

20. The mobile terminal according to claim 18, wherein,
in response to the first search space being a paging search space, the number of bits of the DCI for carrying the PEI is equal to a number of bits of paging downlink control information (Paging DCI); and
in response to the first search space not being a paging search space, the number of bits of the DCI for carrying the PEI is equal to or less than the number of bits of the Paging DCI.

21. The mobile terminal according to claim 18, wherein,
in response to the first search space being a paging search space, the DCI for carrying the PEI comprises a first field and any N fields among a second field, a third field, and a fourth field, wherein N is a positive integer and 0≤N≤3; and
in response to the first search space not being a paging search space, the DCI for carrying the PEI comprises the first field and any M fields among the second field and the third field, wherein M is a positive integer and 0≤M≤2;
wherein the first field is a paging indication field, the second field is a tracking reference signal availability indication field, the third field is an other information field, and the fourth field is a reserved bit field.

22. The mobile terminal according to claim 18, wherein the receiving DCI for carrying the PEI sent by the network device through the first search space comprises:
descrambling, in response to the first search space being a paging search space, a channel for transmitting the DCI for carrying the PEI using a first radio network temporary identifier (RNTI);
wherein, the first RNTI is different from a second RNTI for descrambling a channel for transmitting the Paging DCI.

23. The mobile terminal according to claim 22, wherein the first RNTI is a paging early indication-radio network temporary identifier (PEI-RNTI).
